(19) United States
(12) Patent Application Publication
(10) Pub. No.: US 2015/0194154 A1
(43) Pub. Date: Jul. 9, 2015

(54) METHOD FOR PROCESSING AUDIO SIGNAL AND AUDIO SIGNAL PROCESSING APPARATUS ADOPTING THE SAME

(71) Applicant: SAMSUNG ELECTRONICS CO., LTD., Gyeonggi-do,Suwon-si (KR)

(72) Inventors: Young-woo Lee, Suwon-si (KR); Young-tae Kim, Seongnam-si (KR); Seoung-hun Kim, Hwaseong-si (KR)

(73) Assignee: SAMSUNG ELECTRONICS CO., LTD., Suwon-si (KR)

(21) Appl. No.: 14/407,571

(22) PCT Filed: Jun. 12, 2013
(86) PCT No.: PCT/KR2013/005169

§ 371 Date: Dec. 12, 2014

(30) Foreign Application Priority Data
Jun. 12, 2012 (KR) 10-2012-0062789

(51) Int. Cl. G10L 17/00

(52) U.S. Cl. CPC G10L 17/00

(57) ABSTRACT

A method for processing an audio signal and an audio signal processing apparatus adopting the same are provided. The method for processing an audio signal by a processor comprises matching user information and auditory information, storing matching information indicating that the user information matches to the auditory information, recognizing a user corresponding the user information, searching for the auditory information in response to the user being recognized, and processing the audio signal based on the searched auditory information.

### TECHNICAL FIELD

Apparatuses and methods consistent with exemplary embodiments relate to processing an audio signal, and more particularly to processing an audio signal to recognize a user and correct the audio signal according to user's auditory information.

### BACKGROUND ART

Depending upon an audio system or environment for reproducing an audio signal and auditory capabilities of users who listen to the audio signal, even the same audio signal may be heard differently. Thus, there is a need for optimizing an audio signal in conformity to a sound reproduction environment and auditory capabilities of users.

Currently, Audio/Video (A/V) devices, for example, a TV, a DVD player, and the like, have widely been spread and used, and they have features of processing an audio signal with audio signal processing settings that can be set by a user.

In the related art, however, an audio signal is processed and reproduced based on a predetermined set value and a user's individual auditory capability is not considered. That is, a user's auditory capability and/or preference are not reflected in reproduced audio signals. Further, if a user desires to listen to audio that has been processed with another audio set value, the user should change the audio set value each time.

Accordingly, there is a need for schemes that can automatically provide a user with an audio signal that has been processed according to the user's auditory information.

### SUMMARY OF INVENTION

Exemplary embodiments address at least the above problems and/or disadvantages and provide at least the advantages described below. Also, the exemplary embodiments are not required to overcome the disadvantages described above, and may not overcome any of the problems described above.

Accordingly, an aspect of the present invention provides a method for processing an audio signal and an audio signal processing apparatus adopting the same, which can match and store a user face and auditory information and, if the user face is recognized, process the audio signal according to the auditory information that matches the user face to automatically provide a user with the audio signal processed according to the user's auditory information.

According to one aspect of an exemplary embodiment, a method for processing an audio signal may include matching user information and auditory information; and storing matching information indicating that the user information matches to the auditory information; recognizing to user corresponding to the user information; searching for the auditory information in response to the user being recognized; and processing the audio signal based on the searched auditory information.

The method may further include capturing a facial image of the user; storing the facial image as the user information; performing different corrections with respect to a test audio to output a plurality of corrected test audios; in response to one of the plurality of corrected audios being selected, determining correction processing information applied to the selected test audio as the auditory information; matching the determined auditory information and the facial image; and storing information of the matching between the determined auditory information and the facial image.

The performing the different correction may be performed multiple times by changing frequencies of the test audio.

The different corrections may be boost corrections that increase a decibel level of the test audio by different decibel levels or cut corrections that decrease the decibel level of the test audio by different decibel levels with respect to the test audio.

The method may further include capturing a facial image of the user; storing the facial image as the user information; and outputting pure tones of a plurality of frequencies, determining an audible range of the user with respect to the plurality of frequencies as the auditory information; and matching the determined auditory information and the facial image; and storing information of the matching between the determined auditory information and the facial image.

The processing the audio signal may comprise amplifying or attenuating the audio signal by a gain value determined based on the audible range which is set with respect to each of the plurality of frequencies.

The method may further include capturing a facial image of the user; storing the facial image as the user information; and outputting test audios of a plurality of phonemes at different decibel levels, determining an audible range of the user with respect to the plurality of phonemes as the auditory information based on an input of the user; matching g the determined auditory information and the facial image; and storing information of the matching between the determined auditory information and the facial image.

The processing the audio signal may comprise amplifying or attenuating the audio signal by a gain value determined based on the audible range according which is set with respect to each of the plurality of phonemes.

The auditory information may be received from an external server or a portable device.

According to an aspect of an exemplary embodiment, an audio signal processing apparatus may include a storage configured to store information indicating that user information matches auditory information; a recognition processor configured to recognize a user corresponding to the stored user information; an audio signal processor configured to process an audio signal; and a controller configured to search for the stored auditory information that matches the recognized user and control the audio signal processor to process the audio signal based on the searched auditory information.

The audio signal processing apparatus may further include an imaging unit configured to capture a facial image of the user, wherein the control unit is further configured to store the facial image as the user information, perform different corrections with respect to a test audio to output a plurality of corrected test audios, and in response to one of the plurality of corrected audios being selected, determine correction processing information applied to the selected test audio as the auditory information, match the determined auditory information and the facial image, and store information of the matching between the determined auditory information and the facial image.

The controller may determine the auditory information with respect to a plurality of frequency regions by changing frequencies of the test audio, match the auditory information with respect to the plurality of frequency regions and the facial image, and store information of the matching between the auditory information and the facial image.

The different corrections may be boost corrections that increase a decibel level of the test audio by different levels or cut corrections that decrease the decibel level of the test audio by different levelso.

The audio signal processing apparatus may further include an imaging unit configured to capture a facial image of the user, wherein the controller is further configured to output pure tones of the plurality of frequencies, determine the audible range as the auditory information, match the determined auditory information and the facial image, and store information of the matching in the storage.

The control unit may control the audio signal processor to amplify or attenuate the audio signal by a gain value determined based on the audible range which is set with respect to each of the plurality of frequencies.

The audio signal processing apparatus according tot the aspect of the present invention may further include an audio signal output unit outputting the audio signal; and an imaging unit imaging the user face; wherein the control unit controls the audio signal output unit to output test audios having different levels with respect to a plurality of phonemes, decides a user's audible range with respect to the plurality of phonemes according to a user input of whether the user can hear the test audios, determines the audible range as the auditory information, and matches and stores the determined auditory information and the imaged user face in the storage unit.

The control unit may control the audio signal processing unit to amplify the audio signal by multiplying the plurality of frequencies by a gain value determined by the audible range according to the audible range with respect to the plurality of phonemes.

The auditory information may be received from an external server or a portable device.

According to an aspect of an exemplary embodiment, an audio signal processing apparatus may comprise a storage configured to store user identifying information of a user; an audio signal processor configured to process an input audio signal; and a controller configured to generate auditory information that reflects an auditory capability of the user with respect to a plurality of frequencies or a plurality of phonemes, match the auditory information to the user identifying information, and store information of the matching between the auditory information and the user identifying information.

The controller may be further configured to recognize a user input corresponding to the user identifying information, retrieve the auditory information in response to the user input being recognized, and determine an decibel level adjustment based on the auditory information which is set with respect to each of the plurality of frequencies, wherein the audio signal processor is further configured to amplify or attenuate the input audio signal by a decibel level corresponding to the decibel level adjustment.

The controller may be further configured to recognize a user input corresponding to the user identifying information and retrieve the auditory information in response to the user input being recognized, and determine a decibel level adjustment based on the auditory information which is set with respect to each of the plurality of phonemes, wherein the audio signal processor is further configured to amplify or attenuate the input audio signal by a decibel level corresponding to the decibel level adjustment.

The user input may be a captured facial image of the user or a text input identifying the user.

According to the various embodiments of the present invention as described above, an audio signal can be corrected according to user's auditory information.

### BRIEF DESCRIPTION OF DRAWINGS

The above and other aspects, features and advantages of the present invention will be more apparent from the following detailed description when taken in conjunction with the accompanying drawings, in which:

FIG. 1 illustrates a configuration of an audio signal processing apparatus according to an embodiment of the present invention;

FIGS. 2 to 5 illustrate user preference audio setting user interfaces (UIs) according to various embodiments of the present invention;

FIG. 6 illustrates a method for processing an audio signal according to an embodiment of the present invention; and

FIGS. 7 to 9 illustrate a method for matching and storing a user's facial image and auditory information according to various embodiments of the present invention.

### DETAILED DESCRIPTION

Hereinafter, exemplary embodiments are described in detail with reference to the accompanying drawings.

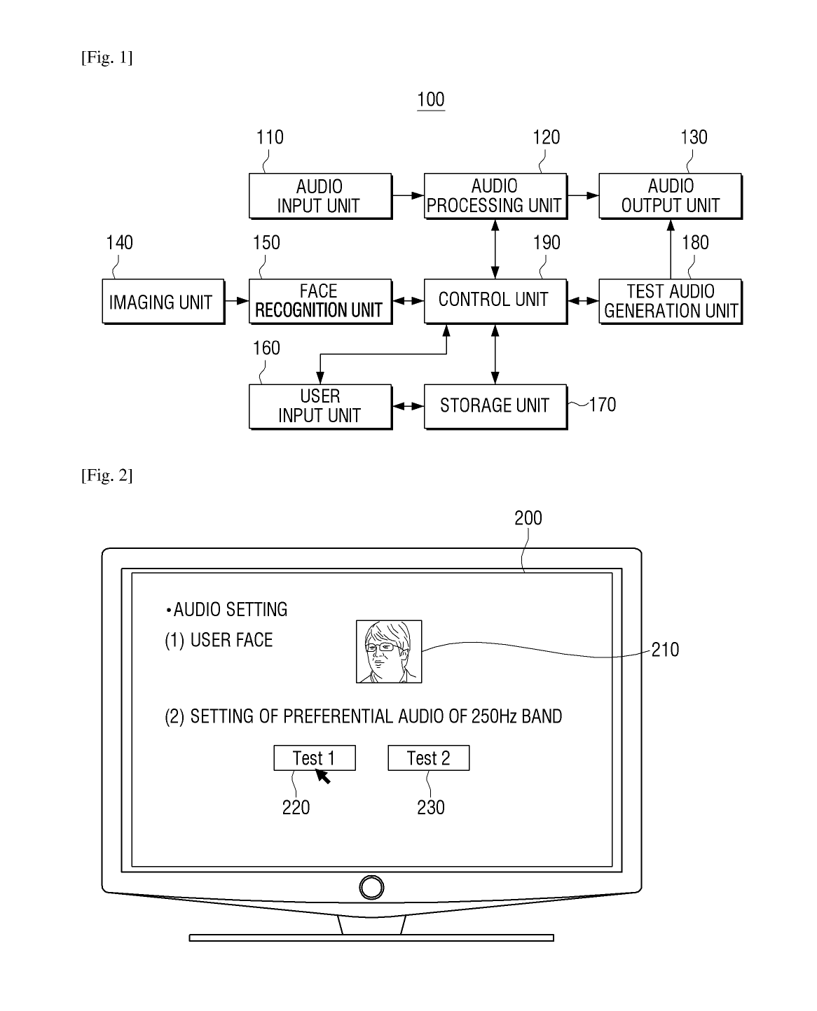

FIG. 1 illustrates configurations of an audio signal processing apparatus according to an exemplary embodiment. As illustrated in FIG. 1, an audio signal processing apparatus 100 may include an audio input unit 110, an audio processing unit 120, an audio output unit 130, an imaging unit 140, a face recognition unit 150, a user input unit 160, a storage unit 170, a test audio generation unit 180, and a control unit 190. The audio signal processing apparatus 100 may be a TV but, is not limited thereto. The audio signal processing apparatus 100 may be a device such as a desk top PC, a DVD player, or a set top box.

The audio input unit 110 may receive an audio signal from an external base station, an external device (for example, a DVD player), and the storage unit 170. In this case, the audio signal may be input together with at least one of a video signal and an additional signal (for example, control signal).

The audio processing unit 120 may process the audio signal that is input under the control of the control unit 190 and transmit the processed audio signal to the audio signal output unit 130. In particular, the audio processing unit 120 may process or correct the input audio signal using auditory information pre-stored in the storage unit 170. For example, the audio processing unit 120 may multiply the input audio signal of a plurality of frequencies or a plurality of phonemes by a gain value so as to amplify the input audio signal. The gain value may vary or be determined according to the user's auditory information. The audio processing unit 120 may also perform an operation of processing the audio signal using the auditory information, and the operation will be described hereinafter.

The audio output unit 130 may output the audio signal processed by the audio processing unit 120. The audio output unit 130 may be implemented by a speaker, but not be limited thereto. The audio output unit 130 may be implemented by a terminal that outputs the audio signal to an external device (not shown).

The imaging unit 140 may image a user face or capture a user's facial image by a user's operation, receive an image signal (for example, frame) that corresponds to the imaged user face or the facial image, and transmit the image signal to the face recognition unit 150. In particular, the imaging unit 140 may be implemented by a camera unit that is composed of a lens and an image sensor. Further, the imaging unit 140 may be provided inside the audio signal processing apparatus 100 (for example, bezel or the like that constitutes the audio signal processing apparatus 100). Alternatively, the imaging unit 140 may be provided outside the audio signal processing apparatus 100 and connected through a wired or wireless network to the audio signal processing apparatus 100.

The face recognition unit 150 may analyze an facial image that the imaging unit 140 generates and recognize a user face corresponding to the facial image signal. Specifically, the face recognition unit 150 may extract a facial feature through analysis of at least one of a symmetrical composition of the facial image, an appearance (for example, shapes and positions of the eye, the nose, and the mouth of a user), hair, color of the eyes, and movement of facial muscles, and then compare the extracted facial feature with pre-stored image data.

The user input unit 160 may receive a user command for controlling the audio signal processing apparatus 100. In this case, the user input unit 160 may be implemented by various input devices such as a remote controller, a mouse, and a touch screen.

The storage unit 170 may store various programs and data that the audio signal processing apparatus 100 may access and load. The storage unit 170 may store matching information that indicates the user's facial image is matched to the user's auditory information. The matching information may be used to process the audio signal according to the user's auditory capability and/or preference.

The test audio generation unit 180 may generate test audio to which correction or adjustment has been applied in a plurality of frequency bands (for example, 250 Hz, 500 Hz, and 1 kHz) in order to set user preference audio. For example, the test audio generation unit 180 may increase or decrease preset decibel levels (for example, 5 dB and 10 dB) of the audio signal in the plurality of frequency bands and output the audio signal.

Further, the test audio generation unit 180 may output pure tones having a plurality of decibel levels with respect to a plurality of frequency bands in order to confirm a user's audible range with respect to the plurality of frequency bands. Further, the test audio generation unit 180 may output test audios having a plurality of decibel levels with respect to a plurality of phonemes in order to decide the user's audible range with respect to the plurality of phonemes. Further, the test audio generation unit 180 may sequentially output test audios having the plurality of decibel levels at a single frequency in order for the user to confirm the user's audible range with respect to the plurality of frequency bands.

The control unit 190 may control operations of the audio signal processing apparatus 100 according to a user command input through the user input unit 160. In order to provide a customized audio according to the user's auditory capability and/or preference, once the face recognition unit 150 recognizes the user face, the control unit 190 may search for the auditory information that matches the recognized user face and process the audio signal according to the auditory information.

Specifically, in order to provide the customized audio according to the user's auditory capability and/or preference, the control unit 190 matches the user's auditory information and the recognized user face in accordance with the user input and store information of the matching in the storage unit 170.

According to an exemplary embodiment, the control unit 190 may determine user preference correction processing information as the auditory information and match and store the auditory information and the user's facial image in the storage unit 170. With reference to FIGS. 2 to 5, a method for determining the user preference correction processing information will be described hereinafter.

As one exemplary embodiment to determine the correction processing information in which the user's preferences are reflected, the control unit 190 may match the auditory information and the user's facial image and store information of the matching based on user preference audio setting user interfaces (UIs) 200 and 300 as shown in FIGS. 2 and 3. The user preference audio setting UIs 200 and 300 may allow the user to select, one at a time, test audios to which a plurality of corrections or adjustments have been made.

Specifically, the control unit 190 stores, in the storage unit 170, a facial image of the user captured by the imaging unit 140.

In order to set user preference audio with respect to one frequency among the plurality of frequencies, the control unit 190 may sequentially output a first test audio to which a first correction has been made and a second test audio to which a second correction has been made at the one frequency. The first correction and the second correction may be corrections that increase or decrease preset decibel levels in one frequency band or at one frequency. For example, the first test audio may be a test audio to which the first correction (for example, correction to boost the present decibel level by 5 dB) has been applied at 250 Hz, and the second test audio may be a test audio to which the second correction (for example, correction to cut the preset decibel level by 5 dB) has been applied at 250 Hz. As shown in FIG. 2, the first test audio may correspond to an icon “Test 1” 220, and the second test audio may correspond to an icon “Test 2” 230.

As shown in FIG. 3, if an icon “Test 1” 320 is selected through a user input, the control unit 190 may display a user preference audio setting UI 300 that allows a user to select one of the first test audio to which the first correction has been applied and a third test audio to which a third correction has been applied at 250 Hz, respectively. The first correction may be a correction to boost the preset decibel level by 5 dB at 250 Hz, and the third correction may be a correction to boost the preset decibel level by 10 dB at 250 Hz. Further, the first test audio may correspond to an icon “Test 1” 320, and the third test audio may correspond to an icon “Test 3” 330.

Further, if the icon “Test 1” 320 is selected, the control unit 190 may determine information, which indicates the decibel of an input audio signal is to be boosted by 5 dB at 250 Hz, as auditory information. However, if the icon “Test 3” 330 is selected, the control unit 190 may determine information, which indicates that the decibel of the input audio signal is to be increased by 10 dB at 250 Hz, as the auditory information. Alternatively, the auditory information may indicate that the decibel of the input audio signal is to be boost by 15 dB.

The control unit 190 may repeat such a process to determine the user preference correction processing information and thereby determine the auditory information with respect to the plurality of frequencies (for example, 500 Hz and 1 kHz).

Further, the control unit 190 may match the user's facial image and the auditory information with respect to the plurality of frequencies and store information of the matching in the storage unit 190.

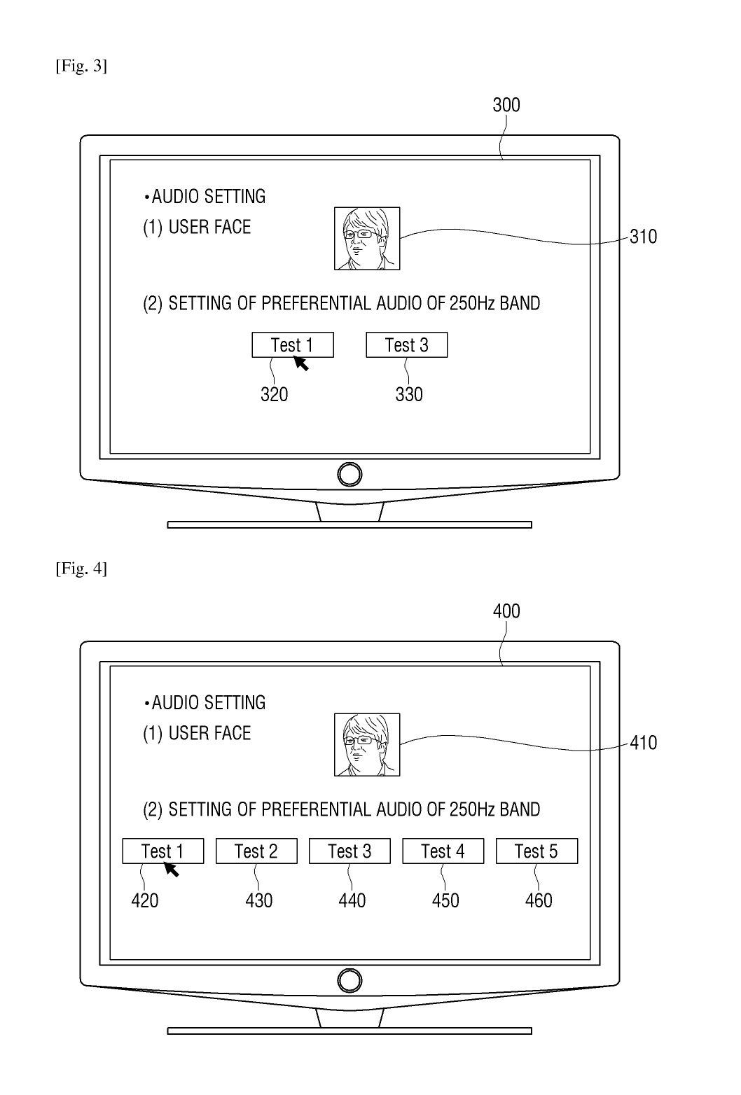

As another exemplary embodiment to determine the correction processing information in which the user's preferences are reflected, the control unit 190 may match the auditory information and the user's facial image and store information of the matching based on a user preference audio setting UI 400 as shown in FIG. 4. The user preference audio setting UI 400 may allow the user to select at a time test audios to which a plurality of corrections have been made with respect to a specific frequency or frequency band.

Specifically, the control unit 190 stores, in the storage unit 170, a facial image of the user captured by the imaging unit 140, and displays the facial image on one region 410 of the user preference audio setting UI 400.

In order to set user preference audio with respect to one frequency among the plurality of frequencies, the control unit 190 may sequentially output first to fifth test audios to which first to fifth corrections have been made at the one frequency. The first to fifth corrections may be corrections that increase or decrease preset decibel levels in one frequency band. For example, the first test audio may be a test audio to which the first correction (for example, correction to boost the preset decibel level by 10 dB) has been applied at 250 Hz, the second test audio may be a test audio to which the second correction (for example, correction to boost the preset decibel level by 5 dB) has been applied at 250 Hz, and the third test audio may be the test audio of which no correction has been applied at 250 Hz. The fourth test audio may be a test audio to which the fourth correction (for example, correction to cut the preset decibel level by 5 dB) has been applied at 250 Hz, and the fifth test audio may be a test audio to which the fifth correction (for example, correction to boost the present decibel level by 5 dB) has been applied at 250 Hz. As shown in FIG. 4, the first test audio may correspond to an icon “Test 1” 420, the second test audio may correspond to an icon “Test 2” 430, and the third test audio may correspond to an icon “Test 3” 440. The fourth test audio may correspond to an icon “Test 4” 450, and the fifth test audio may correspond to an icon “Test 5” 460.

If a specific icon of a test audio is selected through a user input, the control unit 190 may determine correction processing information of the test audio that corresponds to the specific icon as auditory information. For example, if the icon “Test 1” 420 is selected through a user input, the control unit 190 may determine information, which indicates that a preset decibel level of an input audio signal is to be increased by 10 dB at 250 Hz, as auditory information.

Further, the control unit 190 may repeat such a process to determine the user preference correction processing information and thereby determine the auditory information with respect to the plurality of frequencies (for example, 500 Hz and 1 kHz).

Further, the control unit 190 may match the user's facial image and the auditory information with respect to the plurality of frequencies and store information of the matching in the storage unit 190.

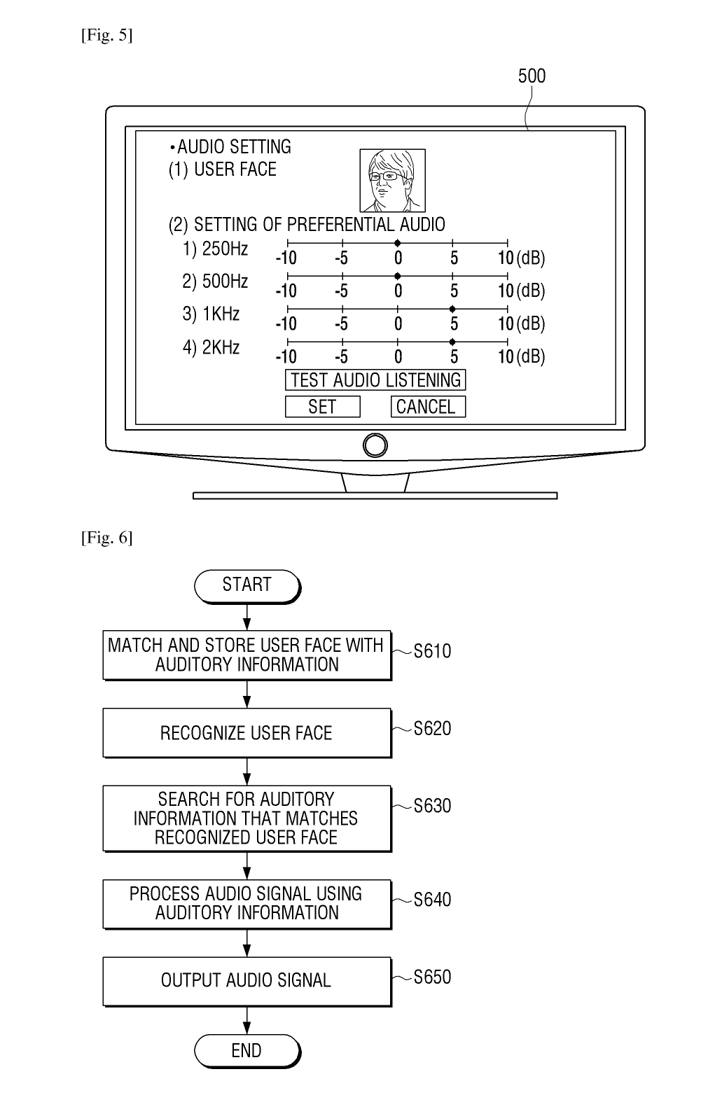

However, the method for sequentially determining the auditory information illustrated in FIGS. 2 to 4 is merely exemplary, and the auditory information may be simultaneously determined with respect to the plurality of frequency bands using the user preference audio setting UI 500 as illustrated in FIG. 5.

The determined auditory information and the user's facial image have been described as being directly matched and stored. However, this is merely exemplary, and other methods may be used to match the auditory information and the user's facial image and store information of the matching. For example, user text information (for example, user name, user ID, and the like) may match to the user's facial image and then information of the matching may be stored so that the user text information corresponds to the auditory information. Further, the user's facial image may match to the user text information and then the user text information may match to the auditory information so that the user's facial image may match to the auditory information.

In another embodiment, the control unit 190 may determine a user's audible range with respect to the plurality of frequencies as the auditory information, and match the audible range to the user's facial image and store information of the matching.

Specifically, the control unit 190 stores, in the storage unit 170, the user's facial image captured by the imaging unit 140. Then, in order to decide the user's audible range, the control unit 190 may control the test audio generation unit 180 to adjust a decibel level of an audio signal with respect to a pure tone having a specific frequency or frequency band among the plurality of frequency bands (for example, 250 Hz, 500 Hz, and 1 kHz) and output the adjusted audio signal.

While the test audio generation unit 180 adjusts the decibel level and outputs the adjusted audio signal, the control unit 190 may decide the audible range with respect to the specific frequency based on a user input (for example, pressing a specific button if the user is unable to hear). For example, if the user input is received when the pure tone having 20 dB is output and the decibel level of the pure tone is adjusted with respect to the pure tone having the frequency of 250 Hz, the control unit 190 may decide that an auditory threshold of 250 Hz is 20 dB and the audible range is equal to or more than 20 dB.

The control unit 190 may decide the audible ranges of other frequency bands by performing the above-described process with respect to other frequency bands. For example, the control unit 190 may decide that the audible range of 500 Hz is equal to or more than 15 dB and the audible range of 1 kHz is equal to or more than 10 dB.

Further, the control unit 190 may determine the user's audible range with respect to the plurality of frequency bands as the auditory information, match the user's facial image and the determined auditory information, and store information of the matching in the storage unit 170.

In the above-described embodiment, the audible range has been decided using a pure tone. However, this is merely exemplary, and other methods may be used to decide the audible range. For example, the audible range may be decided by sequentially outputting test audios having a plurality of decibel levels with respect to a specific frequency and deciding the number of test audios that a user can hear according to user inputs.

In still another embodiment, the control unit 190 may determine an audible range of a user with respect to a plurality of phonemes and set the audible range as the auditory information. The control unit 190 may match the audible range and the user's facial image and store information of the matching.

Specifically, the control unit 190 stores, in the storage unit 170, the user's facial image captured by the imaging unit 140. Then, the control unit 190 may control the test audio generation unit 180 to adjust a decibel level of an audio signal with respect to a specific phoneme among the plurality of phonemes (for example, “ah” and “se”) and output the adjusted audio signal.

While the test audio generation unit 180 adjusts the decibel level and outputs the adjusted audio signal, the control unit 190 may decide the audible range with respect to the specific phoneme based on a user input (for example, pressing a specific button if the user is unable to hear). For example, if the user input is received when the test audio having 20 dB is output and the decibel level is adjusted with respect to the test audio having a phoneme “ah”, the control unit 190 may decide that an auditory threshold of the phoneme “ah” is 20 dB and the audible range is equal to or more than 20 dB.

The control unit 190 may decide audible ranges of other phonemes by performing the above-described process with respect to other phonemes. For example, the control unit 190 may decide that an audible range of a phoneme “se” is equal to or more than 15 dB and an audible range of a phoneme “bee” is equal to or more than 10 dB.

Further, the control unit 190 may determine the user's audible range with respect to a plurality of phonemes as the auditory information The control unit 190 may match the user's facial image to the determined auditory information and store information of the matching in the storage unit 170.

In various embodiments as described above, the auditory information may be determined, and the determined auditory information and the user's facial image may be matched and stored.

If the user face captured by the imaging unit 140, the control unit 190 may recognize the captured user face through the face recognition unit 190. Specifically, the control unit 190 may decide whether a pre-stored user facial image matches to the captured user face to recognized the captured user face.

If the pre-stored user's facial image matches to the captured user face, the control unit 190 searches for auditory information that corresponds to the pre-stored user's facial image, and controls the audio processing unit 120 to process an input audio signal using the searched auditory information.

Specifically, if a user preference audio setting is determined as the auditory information, the control unit 190 may control the audio processing unit 120 to process the input audio signal according to correction processing information stored in the storage unit 170. If the correction processing information includes information to perform a correction that increases or decreases the audio signal to a preset level at a specific frequency, the control unit 190 may control the audio processing unit 120 to perform the correction that increase or decreases the audio signal to the preset decibel level according to the correction processing information.

In still another embodiment, if the audible range with respect to the plurality of frequencies is determined as the auditory information, the control unit 190 may control the audio signal processing unit 120 to amplify the input audio signal by a gain value. The gain value is determined based on an audible range that is measured and set at each of the plurality of frequencies. For example, if the audible range of 250 Hz is equal to or more than 20 dB, the audible range of 500 Hz is equal to or more than 15 dB, and the audible range of 1 kHz is equal to or more than 10 dB, the control unit 190 may multiply the audio signal of 250 Hz by a gain value of 2, multiply the audio signal of 500 Hz by a gain value of 1.5, and multiply the audio signal of 1 kHz by a gain value of 1, respectively.

In still another embodiment, the control unit 190 may control the audio signal processing unit 120 to multiply a decibel level of a plurality of phonemes of the input audio signal by different gain values. The gain values are determined based on an audible range that is measured and set with respect to each of the plurality of phonemes. For example, if the audible range of a phoneme “ah” is equal to or more than 20 dB, the audible range of a phoneme “se” is equal to or more than 15 dB, and the audible range of a phoneme “she” is equal to or more than 10 dB, the audible range of the plurality of frequencies may be derived using the audible ranges of the phonemes, and the control unit 190 may amplify the input audio signal of the plurality of frequencies, by a gain value that corresponds to the derived audible range.

As described above, if a user's face is recognized, an audio signal is processed using auditory information that matches the recognized face, and thus the user can listen to the audio signal that is automatically adjusted according to the user's auditory capability and/or preference without additional manual operations.

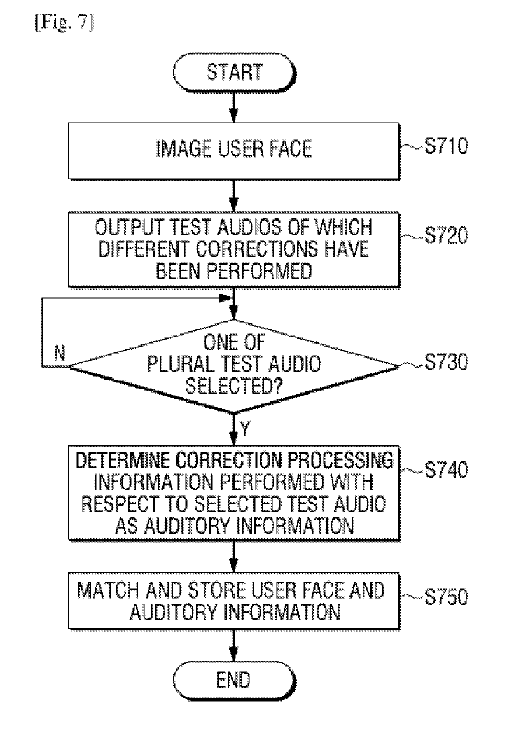

Hereinafter, a method for processing an audio signal will be described in detail with reference to FIGS. 6 to 9. FIG. 6 is a flowchart illustrating a method for processing an audio signal according to an exemplary embodiment.

First, the audio signal processing apparatus 100 matches a user's facial image to auditory information and store information of the matching S610) Various embodiments of matching and storing will be described with reference to FIGS. 7 to 9.

FIG. 7 is a flowchart illustrating a method for matching a user's facial image and auditory information and storing information of the matching when user preference audio setting is determined as the auditory information according to an exemplary embodiment.

First, the audio signal processing apparatus 100 captures a user's facial image using the imaging unit 140 S710. The capturing may be performed after auditory information is determined as in S740.

Then, the audio signal processing apparatus 100 outputs test audios to which different corrections have been applied S720. Specifically, the audio signal processing apparatus 100 may perform the corrections so that the audio signal of various frequencies are increased or decreased to a preset decibel level. The audio signal processing apparatus 100 may output a plurality of test audios to which the correction has been made in various frequency bands or at various frequencies.

Then, the audio signal processing apparatus 100 decides whether one of the plurality of test audios is selected S730.

If one of the plurality of test audios is selected at S730, the audio signal processing apparatus 100 determines correction processing information performed with respect to the selected test audio (i.e., user preference audio setting) as auditory information S740.

Then, the audio signal processing apparatus 100 matches the user's facial image and the auditory information S750.

As described above, the audio signal is equalized through the user preference audio setting, and as a result, the user can hear the input audio signal with audio setting that the user prefers.

FIG. 8 is a flowchart illustrating a method for matching a user's facial image and auditory information and storing information of the matching when the audible range with respect to a plurality of frequency bands is determined as auditory information.

First, the audio signal processing apparatus 100 captures a user's facial image using the imaging unit 140 S810. The capturing may be performed after auditory information is determined as in S840.

Then, the audio signal processing apparatus 100 outputs pure tones with respect to a plurality of frequency regions S820. Specifically, the audio signal processing apparatus 100 may output the pure tones with respect to the plurality of frequency regions while adjusting a volume level.

The audio signal processing apparatus 100 decides an audible range of the user according to the user's input, and determines the audible range as auditory information S830. Specifically, while a volume level of a test pure tone is adjusted with respect to a specific frequency and output, the audio signal processing apparatus 100 decides whether the user can hear the test pure tone based on a user input. If the user input is received when a first volume level is set with respect to the specific frequency, the audio signal processing apparatus 100 decides that the first volume level is an auditory threshold with respect to the specific frequency. The audio signal processing apparatus 100 sets a volume level that is equal to or larger than the auditory threshold as the audible range. Further, the audio signal processing apparatus 100 may determine the audible range with respect to a plurality of frequency bands as the auditory information by performing the above-described process with respect to each of the plurality of frequency bands.

Then, the audio signal processing apparatus 100 matches the user's facial image and the auditory information S840.

As described above, an audible range with respect to a plurality of frequency bands is determined as auditory information and an input audio signal is amplified at frequency bands that the user is not able to hear properly. Thereby, the user can better hear an audio signal of certain frequency bands that the user could not clearly hear.

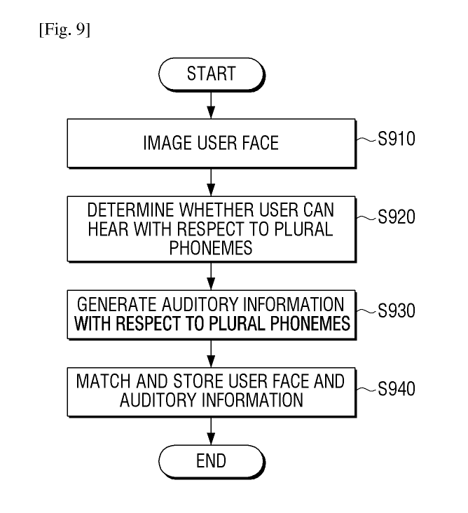

FIG. 9 is a flowchart illustrating a method for matching a user's facial image and auditory information and storing information of the matching when an audible range with respect to a plurality of phonemes is determined as auditory information.

First, the audio signal processing apparatus 100 captures a user's facial image using the imaging unit 140 S910.

Then, the audio signal processing apparatus 100 decides whether the user can hear each of a plurality of phonemes S920. Specifically, while a volume level of a test audio is adjusted with respect to a specific phoneme and output, the audio signal processing apparatus 100 decides whether the user can hear the specific phoneme based on a user input. If the user input is received when a second volume level is set with respect to the specific phoneme, the audio signal processing apparatus 100 decides that the second volume level is an auditory threshold with respect to the specific phoneme. The audio signal processing apparatus 100 sets a volume level that is equal to or larger than the auditory threshold as the audible range. Further, the audio signal processing apparatus 100 may determine the audible range with respect to the plurality of phonemes by performing the above-described process with respect to each of the plurality of phonemes.

Then, the audio signal processing apparatus 100 may generate the auditory information with respect to the plurality of phonemes S930. Specifically, the audio signal processing apparatus 100 may derive the audible range of the plurality of frequencies and generates the auditory information using the audible range with respect to the plurality of phonemes.

Then, the audio signal processing apparatus 100 may match the user's facial image and the auditory information and store information of the matching S940.

As described above, an audible range with respect to a plurality of frequency bands is determined as auditory information and an input audio signal is amplified in frequency bands that the user is not able to hear properly. Thereby, the user can hear the audio signal including the frequency bands that the user could not hear well.

In addition to the above-described embodiments illustrated in FIGS. 7 to 9, other methods may be used to match the auditory information and the user's facial image and store information of the matching.

Referring again to FIG. 6, the audio signal processing apparatus 100 recognizes the user face using the face recognition unit 150 S620. Specifically, the audio signal processing apparatus 100 may recognize the user face by extracting a facial feature through analysis of at least one of a symmetrical composition of the user face, an appearance (for example, shapes and positions of the eyes, the nose, and the mouth of the user), hair, color of the eyes, and movement of facial muscles, and then comparing the extracted facial feature with pre-stored image data.

Then, the audio signal processing apparatus 100 searches for auditory information that matches the recognized user face S630. Specifically, the audio signal processing apparatus 100 may search for the auditory information that matches the recognized user face based on the user's facial image and the auditory information pre-stored in step S610.

Then, the audio signal processing apparatus 100 processes the audio signal using the auditory information S640. Specifically, if a user preference audio setting is determined as the auditory information, the audio signal processing apparatus 100 may process the audio signal according to correction processing information stored in the storage unit 170. Further, if an audible range with respect to a plurality of frequency bands is determined as the auditory information, the audio signal processing apparatus 100 may amplify the audio signal by a gain value that is determined by an audible range which is measured and set with respect to each of the plurality of frequency bands of the audio signal. Further, if an audible range with respect to a plurality of phonemes is determined as the auditory information, the audio signal processing apparatus 100 may amplify the audio signal by a gain value that is determined by an audible range which is measured and set with respect to the plurality of phonemes. According to the method for processing the audio signal as described above, if a user's face is recognized, an audio signal is processed using auditory information that matches the user face, and thus the user can listen to the audio signal that is automatically adjusted according to the user's auditory capabilities and/or preferences without additional manual operations or inputs.

In the above-described embodiment, it has been described that the user directly determines the auditory information using the audio processing apparatus 100. However, this is merely exemplary, and the auditory information may be received through an external device or server. For example, a user may download the auditory information diagnosed in a hospital from an external server, match the auditory information and the user's facial image, and store information of the matching. Further, the user may determine the user's auditory information using a mobile phone, transmit the auditory information to the audio signal processing apparatus 100, and match the auditory information and the facial image, and store the information of the matching.

A program code for performing the method for processing an audio signal according to the various embodiments may be stored in various types of non-transitory recording media. For example, the program code may be stored in various types of recording media that can be read by a terminal, such as a hard disk, a removable disk, a USB memory, and a CD-ROM.

While the invention has been shown and described with reference to certain embodiments thereof, it will be understood by those skilled in the art that various changes in form and detail may be made therein without departing from the spirit and scope of the present invention, as defined by the appended claims.

1. A method for processing an audio signal by a processor comprising;
matching user information and auditory information;
storing matching information indicating that the user information matches to the auditory information;
recognizing a user corresponding the user information;
searching for the auditory information in response to the user being recognized; and
processing the audio signal based on the searched auditory information.

2. The method for processing an audio signal as claimed in claim 1, further comprising:
capturing a facial image of the user;
storing the facial image as the user information;
performing different corrections with respect to a test audio to output a plurality of corrected test audios;
in response to one of the plurality of corrected test audios being selected, determining correction processing information applied to the selected test audio as the auditory information;
matching the determined auditory information and the facial image; and
storing information of the matching between the determined auditory information and the facial image.

3. The method for processing an audio signal as claimed in claim 2, wherein the performing the different corrections is performed multiple times by changing frequencies of the test audio.

4. The method for processing an audio signal as claimed in claim 2, wherein the different corrections are boost corrections that increase a decibel level of the test audio by different decibel levels or cut corrections that decrease the decibel level of the test audio by different decibel levels.

5. The method for processing an audio signal as claimed in claim 1, further comprising:
capturing a facial image of the user;
storing the facial image as the user information;
outputting pure tones of a plurality of frequencies;
determining an audible range of the user with respect to the plurality of frequencies as the auditory information;
matching the determined auditory information and the facial image; and
storing information of the matching between the determined auditory information and the facial image.

6. The method for processing an audio signal as claimed in claim 5, wherein the processing the audio signal comprises amplifying or attenuating the audio signal by a gain value determined based on the audible range which is set with respect to each of the plurality of frequencies.

7. The method for processing an audio signal as claimed in claim 1, further comprising:
capturing a facial image of the user;
storing the facial image as the user information;
outputting test audios of a plurality of phonemes at different decibel levels;
determining an audible range of the user with respect to the plurality of phonemes as the auditory information based on an input of the user;
matching the determined auditory information and the facial image; and
storing information of the matching between the determined auditory information and the facial image.

8. The method for processing an audio signal as claimed in claim 7, wherein the processing the audio signal comprises amplifying or attenuating the audio signal by a gain value determined based on the audible range which is set with respect to each of the plurality of phonemes.

9. The method for processing an audio signal as claimed in claim 1, wherein the auditory information is received from an external server or a portable device.

10. An audio signal processing apparatus comprising:
a storage configured to store information indicating that user information matches auditory information;
a recognition processor configured to recognize a user corresponding to the stored user information;
an audio signal processor configured to process an audio signal; and
a controller configured to search for the stored auditory information that matches the recognized user and control the audio signal processor to process the audio signal based on the searched auditory information.

11. The audio signal processing apparatus as claimed in claim 10, further comprising:
an imaging unit configured to capture a facial image of the user,
wherein the controller is further configured to:
store the facial image as the user information,
perform different corrections with respect to a test audio to output a plurality of corrected test audios,
in response to one of the plurality of corrected test audios being selected, determine correction processing information applied to the selected test audio as the auditory information,
match the determined auditory information and the facial image,
and store information of the matching between the determined auditory information and the facial image.

12. The audio signal processing apparatus as claimed in claim 11, wherein the controller is further configured to
determine the auditory information with respect to a plurality of frequency regions by changing frequencies of the test audio,
match the auditory information with respect to the plurality of frequency regions and the facial image, and
store information of the matching between the auditory information and the facial image.

13. The audio signal processing apparatus as claimed in claim 11, wherein the different corrections are boost corrections that increase a decibel level of the test audio by different levels or cut corrections that decrease the decibel level of the test audio by different levels.

14. The audio signal processing apparatus as claimed in claim 10, further comprising:
an imaging unit configured to capture a facial image of the user,
wherein the controller is further configured to output pure tones of the plurality of frequencies, determine the audible range as the auditory information, match the determined auditory information and the facial image, and store information of the matching in the storage.

15. The audio signal processing apparatus as claimed in claim 14, wherein the controller is further configured to control the audio signal processor to amplify or attenuate the audio signal by a gain value determined based on the audible range which is set with respect to the plurality of frequencies.

16. The method for processing an audio signal as claimed in claim 1, wherein the user information corresponds to a facial image of the user or a text input identifying the user.

17. An audio signal processing apparatus comprising:
a storage configured to store user identifying information of a user;
an audio signal processor configured to process an input audio signal; and
a controller configured to generate auditory information that reflects an auditory capability of the user with respect to a plurality of frequencies or a plurality of phonemes, match the auditory information to the user identifying information, and store information of the matching between the auditory information and the user identifying information.

18. The audio signal processing apparatus of claim 17, wherein the controller is further configured to recognize a user input corresponding to the user identifying information, retrieve the auditory information in response to the user input being recognized, and determine an decibel level adjustment based on the auditory information which is set with respect to each of the plurality of frequencies,
wherein the audio signal processor is further configured to amplify or attenuate the input audio signal by a decibel level corresponding to the decibel level adjustment.

19. The audio signal processing apparatus of claim 17, wherein the controller is further configured to recognize a user input corresponding to the user identifying information and retrieve the auditory information in response to the user input being recognized, and determine an decibel level adjustment based on the auditory information which is set with respect to each of the plurality of phonemes,
wherein the audio signal processor is further configured to amplify or attenuate the input audio signal by a decibel level corresponding to the decibel level adjustment.

20. The audio signal processing apparatus of claim 19, wherein the user input is a captured facial image of the user or a text input identifying the user.
